(19) United States
(12) Patent Application Publication
(10) Pub. No.: US 2010/0169055 A1
(43) Pub. Date: Jul. 1, 2010

(54) SYSTEM AND METHOD FOR THREE-DIMENSIONALLY REPRESENTING A HAIRCUT, AND ELEMENT FOR SYMBOLICALLY REPRESENTING A HAIR LENGTH

(76) Inventors: Thomas Kobeck, Taufkirchen/Vils (DE); Rainer Stohr, Freising (DE)

Correspondence Address: BARLOW, JOSEPHS & HOLMES, LTD., 101 DYER STREET, 5TH FLOOR, PROVIDENCE, RI, 02903, US

(21) Appl. No.: 12/529,848

(22) PCT Filed: Feb. 15, 2008
(86) PCT No.: PCT/EP2008/051895

§ 371 Date: Dec. 29, 2009

(30) Foreign Application Priority Data
Mar. 8, 2007 (DE) 10 2007 011 405.4

(51) Int. Cl. G06F 17/50; G06G 7/48

(52) U.S. Cl. 703/1; 703/6

(57) ABSTRACT

The invention relates to a system for three-dimensional representation of a haircut including a model head (1), and a plurality of elements (2, 2a, 2b, 2a′, 2b′) variable in length for symbolic representation of hair lengths. The invention also relates to a corresponding method as well as an element for symbolic representation of a hair length.

### TECHNICAL FIELD

The invention relates to a system and a method for three-dimensional representation of a haircut. The invention also relates to an element for symbolic representation of a hair length.

### PRIOR ART

From DE 80 23 257 U1, a demonstration model head for hairstyles is known. A surface area of the model head corresponding to the hairiness is provided with a hook-and-loop tape, to which plural model pieces of strands of hair each corresponding to a strand of hair can be attached by means of a frieze band coupling piece, respectively. The model pieces of strands of hair are formed as flag-like plate parts and are substantially all realized uniformly. A disadvantage of this configuration is to be considered in that only a relatively imprecise representation of a haircut is possible with the very largely dimensioned elements. Moreover, the attachment of these large and thus also relatively heavy model pieces of strands of hair is only possible in very insufficient manner. Therefore, in particular, model pieces attached to the back of the head or to the neck, respectively, relatively often fall off or at least detach from the hook-and-loop tape insofar as they can no longer make a defined contribution to a desired hairstyle representation.

Moreover, from DE 10 2005 053 507 A1, a system for three-dimensional representation of haircuts is known. Bores are produced in a model head in defined invariable regions, into which plate-like elements modeled on passees can be inserted. The plate-like elements each have two plug pins. In the known system, the representation can only be ensured in very insufficient manner, since here too, the haircut can only be symbolized very imprecisely due to the size and the restricted shaping of these fittable elements. Moreover, the flexibility of this system is considerably limited since the specific elements can only be attached to the head in certain positions due the specifically formed plug mechanism. Due to the shaping of a curved head, the attachment of the fixed bores and the shaping of the elements, here too, the usability is substantially restricted. Due to these geometric conditions, prefabricated elements can only be attached to the head in specific positions. Furthermore, here too, the positionally stable attachment of these elements is only possible in limited manner. In particular, after repeated use, signs of wear can occur due to abrasion or the like, which cause permanent fall-out of the elements, in particular if they are attached to the back of the head or in the neck region. Moreover, a plurality of different elements has to be provided to be able to represent different haircuts. Besides increased expenditure for the production, this also requires considerable place requirement for the provision and storage of the plurality of required elements.

Besides the representation of passees in cutting different haircuts on the one hand, it is equally important for a trainee or an advanced training person in the hairdressing profession, on the other hand, to know or to be able to imagine, respectively, the lengths of the hairs underlying a haircut in the different head sections.

### PRESENTATION OF THE INVENTION

It is the object of the present invention to provide a system and a method, by which the three-dimensional representation of haircuts can be effected more precisely and with lower effort. Furthermore, an element for more precise representation of hair lengths is to be allowed.

This object is solved by a system having the features according to claim 1, and a method having the features according to claim 33. Furthermore, this is solved by an element according to claim 32.

A system according to the invention for three-dimensional representation of a haircut includes a model head, which is modeled on a human head and is formed as an artificial model head. Moreover, the system includes a plurality of elements variable in length, which are formed for symbolic representation of hair lengths. By this plurality of elements variable in length, specific lengths of one or more hairs on the head in different head sections can be represented.

In this connection, it is essential for a trainee or an advanced training person in the hairdressing profession that he/she is able to correctly dimension the hair lengths in the individual zones of the head for making a specific haircut.

In particular, in this connection, it is essential that a person working in the hairdressing profession, is able to imagine the structure of the haircut. By a structure, the length arrangement of the hairs across the head curvature is understood, if these hairs are each disposed in the angle of 90 degrees to the scalp. Thus, a structure represents a surface, which is spanned by the tips of the hairs, which all are each disposed in the angle of 90 degrees to the head surface.

By the system according to the invention, the three-dimensional representation of haircuts can be substantially rendered more precisely and in particular the length of separate hairs with respect to the individual haircut and with respect to the respective specific head section can be allowed. By the length variability of the elements, thereby, the precision can be substantially improved and moreover, due to the plurality of these elements, the structure of a haircut can be shown not only roughly, but very finely structured. Thereby, the often very complex structure of a haircut can be represented substantially more precisely for a trainee or an advanced training person, and thereby, the total representation can also be rendered more precisely. Thereby, a substantially better general view also results for the inspection, and in the finished state of a haircut representation, this more precise general view can also be better comprehended and memorized.

In particular for trainees as well as advanced training persons, thereby, the learning success can be substantially improved.

Preferably, an element variable in length includes at least two partial elements, which are formed for symbolic representation of the hair length and connected to each other. The flexible use of the element variable in length can thereby be improved. In particular, the specific length adjustment can thereby be rendered more precisely.

In particular, it can be provided that the length of an element variable in length is reversibly variable. Thereby, the element can be used in manifold manner and different lengths can arbitrarily often be adjusted and again be varied. Besides high functionality, thereby, a non-destructive and repeatable effect of length variation can be repeated arbitrarily often as well.

In particular, an element variable in length is itself variable in length, in particular reversibly variable in non-destructive manner. In particular in axial longitudinal direction of the element variable in length, the length variability is formed, in particular reversibly variable. In axial direction of the element variable in length, thus, a shortening or extension of the element is formed in its axial length. In particular, the element variable in length is formed linearly, and the reversible length variation is provided in the linear shaping of the element, wherein in particular in case of remaining or maintained linearity, respectively, the length variation is adjustable. Therefore, the linear element, which is then especially rod-shaped, is in particular reversibly adjustable in its axial length, which is equally oriented to the linear extension. In particular, the element variable in length is attached to the model head in stationary manner, and upon the length variation, the position of the element as a whole relative to the model head is the same. Then, only the length adjustment of the element itself is provided, a relative movement of the element as a whole to the model head is not given. Without having to displace the element relatively to the model head as a whole, then, a length of the element in particular extending across the head surface, can be precisely adjusted with a precision repeatable arbitrarily often without wear of the element and/or of the model head. Furthermore, thereby, a plurality of similarly formed elements can be used, since they each are adjustable individually in their axial lengths depending on need. Thereby, the manufacture can be simplified and the entire system can be configured simpler, since a plurality of different elements is no longer required. Furthermore, thus, it is no longer required to form a complex cavity in the model head in order to allow slide-in, in particular far slide-in of elements into the model head. The depth, by which such an element variable in length extends into the model head, in particular the at least partially hollow model head, can be minimally formed and then remains unchanged even upon length variation of the element. Thereby, the model head can also be simpler formed. For example, it then can be formed as a solid head without interior cavities, whereby the manufacture can be effected simpler and more inexpensive. Moreover, thus, the problem that a plurality of elements far extending into the model head, which moreover also require a different amount of space and distance in the model head by the slide-in and extraction, impede each other can also be solved. Exactly if the adjustment is only possible by the movement of an element as a whole relative to the model head, for example by sliding-in and extracting, these impediments in the model head can occur. Thereby, the user-friendliness is restricted on the one hand, and the general usability for representing very different hairstyles is also only possible within narrow bounds. Then, the elements can for example get caught in the interior of the model head or mutually buckle such that here too, not only high wear is present. Furthermore, in such implementations, it is a disadvantage that exactly on the lateral head surface, approximately near the ear, such an insertion of elements, which can only be moved as a whole relatively to the model head, is not possible or can only be performed with very short elements since they then extend transversely to the model head in the interior thereof, and can be formed only very shortly due to a small head width. This also applies to the elements introduced from the top, since the head height is also restricted. Thereby, hairstyles with long hair cannot be represented or be represented in insufficient manner. Moreover, by such transverse extension, at least the elements coming from the top are impeded. Thereby, only a very limited number of such elements can be used, the positions of introduction of which on the model head also have to be preset and matched to each other in order to be able to limit the mutual impediment in the interior of the model head.

It can be provided that such an element variable in length is formed as a telescopic device and the at least two partial elements are movable relatively to each other in the direction of the longitudinal axis. The telescopic device allows the adjustment of most diverse lengths, whereby depending on the local positioning of the element variable in length on the model head, a plurality of different hair lengths can be symbolically represented in local manner.

Preferably, it is provided that the length variation of an element variable in length is continuously possible. Thereby, any lengths can be adjusted very precisely. However, it can also be provided that the element variable in length is formed for adjusting discrete lengths, and thereby, thus, a plurality of specific lengths can each be preset and represented. In case of an element variable in length with at least two partial elements, in such an implementation, it can be provided that the movement in the direction of the longitudinal axis and thus the length adjustment is predefined by specifically predefined locking steps.

However, it can also be provided that the reversible length adjustment of an element variable in length is provided by at least two non-destructively detachable elements. In such an implementation, a first partial element can be put together with at least a second partial element by a plug device, and thereby, an individual length of the element variable in length can be adjusted. If it is to be varied again, thus, at least one partial element can be removed again and one or more further partial elements can be fitted. In such a configuration, partial elements can all have the same length. It can also be provided that they have different lengths. Thereby, the flexibility with regard to the representation of very different hair lengths can be increased over again and the length adjustment can be rendered more precisely.

For example, the partial elements can also be connectible in non-destructively detachable manner by screwing to each other. For this, a partial element can have a male thread, which can engage with a female thread of another partial element.

However, it can also be provided that an element variable in length is only irreversibly variable in length. In such an implementation, for example, it can be provided that a one-part element variable in length is formed with at least one predefined predetermined breaking point. If the length of the element is to be reduced in this way, a separation of the at least two partial elements can be made at the predetermined breaking point, which for example can be possible by simply breaking off. Thereby too, an individual length adjustment of an element can be allowed.

Both separated partial elements preferably can then again be used as distinct elements for symbolic representation of the hair length. Here too, it can be provided that the partial elements of such an element variable in length all substantially have the same length. However, it can also be provided that a one-part element variable in length is formed, in which the predetermined breaking points are disposed such that at least two partial elements with different lengths are included. It can be provided that the partial elements of such an element variable in length with predetermined breaking points have a length smaller than or equal to 10 cm, in particular smaller than or equal to 5 cm, especially smaller than or equal to 3 cm and particularly smaller than or equal to 1 cm.

An implementation similar to a plug set, in which an element variable in length has two partial elements, which are reversibly and therefore non-destructively separable and can be assembled again, can have these lengths according to the above-mentioned dimensions, too.

If an element variable in length includes at least two partial elements, which are movable relatively to each other, thus, in addition to a telescopic device, a configuration according to a pivoting device can also be provided. In such an implementation, the two partial elements can be connected to a pivot hinge. Thereby, an implementation similar to a folding meter (pocket rule) is also possible.

Preferably, the element variable in length is formed resistant to bending. By an implementation resistant to bending, it is in particular understood that the element variable in length is rigid with respect to movements, which are not effected in the direction of the longitudinal axis. By resistant to bending, it is also understood that substantial deflection of the element variable in length does not occur if it is in particular only subject to gravity.

In particular, it is advantageous if an element variable in length is formed rod-shaped. By such a configuration, the symbolic representation of hairs and hair lengths can be effected in particularly comprehensible and realistic manner. In particular, it is advantageous therein if an element variable in length has an outer diameter smaller than or equal to 7 mm, in particular smaller than or equal to 5 mm, especially smaller than or equal to 3 mm.

If the element variable in length is only formed of one partial element, it can be formed with a very small outer diameter. Besides an improved symbolic representation of hairs or bundles of hair with a relatively small number of hairs, thereby, a very high number of such elements variable in length can also be attached to the model head. Thereby too, the precision of the three-dimensional representation of a haircut can be improved over again. Not least, thus, the structure of the haircut can also be represented in refined manner by the plurality of additionally attachable elements variable in length.

However, in a configuration of an element variable in length with at least two partial elements movable relatively to each other in the longitudinal axis direction, a rod-shaped element with a relatively small outer diameter can also be allowed. In particular with telescopic devices formed in this respect, in which the partial elements can be slid into each other in the longitudinal axis direction, a relatively small outer diameter can be generated. Thus, even with a telescopic formation of an element variable in length, relatively thin rods can be allowed, whereby here too, the number of elements variable in length attachable to the model head can be very high. In particular, in principle, by such a rod-shaped formation of an element variable in length, the number density can be substantially higher than in other configurations.

Preferably, a rod-shaped element variable in length is formed free of corners, in particular round, in cross-section.

However, in principle, it can also be provided that an element variable in length is not formed rod-shaped, but otherwise. In particular, it can also be provided that an element variable in length is formed plate-like and includes different contour pathways. By such a configuration, the precision of the three-dimensional representation of a haircut can be reduced, nevertheless a sufficient representation can optionally be ensured even in this respect, in particular due to the variability in length.

In particular, an element variable in length is disposed on the model head, in particular in the surface area corresponding to the hairiness, such that it is substantially perpendicularly oriented to the head surface. Exactly this configuration also allows the representation of the structure of a haircut, since besides the individual length adjustments of the elements variable in length, the respectively substantially perpendicular junction of an element variable in length with the head surface is also provided.

In an advantageous implementation, it is provided that an element variable in length can be non-destructively detachably attached to the model head. In such an implementation, it can be provided that an element variable in length is detachably attached to the head surface. For example, an attachment by means of magnets or a Velcro fastener (hook-and-loop connection) or the like can be provided here. In case of a non-destructively detachable attachment, it can also be provided that the head is formed of a resilient material at least in the surface area corresponding to the hairiness of a human head and the volume delimited thereby. In this connection, the resilient material is provided such that insertion of the elements variable in length is ensured. Moreover, the material is preferably formed such that positionally exact retention of the elements variable in length therein is also ensured. It proves particularly advantageous if the resilient material is formed self-closing after removal of an element variable in length. In particular, in such a configuration, the material of the model head and in particular of the volume region, which is delimited by the surface area corresponding to the hairiness of the human head, can be formed of styrofoam or foamed plastic or the like. Similarly, it can be provided that this material is a suitable modeling mass or the like.

However, moreover, it can also be provided that a plurality of pre-fabricated openings is formed in the model head, into which an element variable in length is respectively insertable. In such a configuration, the head can also be formed of wood, metal, plastic or the like. A formation of glass, in particular breaking-resistant, can also be provided.

It proves particularly preferred if an element variable in length is integrated on the model head. By such a formation, a plurality of elements variable in length can be disposed in predefined and substantial surface areas of the model head. In particular, in such an integral formation, it is advantageous that the elements variable in length, which advantageously are present in a great plurality, cannot fall off from the model head, and thus also are not lost. Moreover, in such an implementation, the elements variable in length are also effectively ready to hand at all times, and misplacing or losing can thereby be prevented.

It proves particularly preferred if the elements variable in length are integrally disposed on the model head and cannot be removed from the model head in normal employment. However, preferably, it can be provided that upon repair or for replacement, an element variable in length can be removed from the model head in non-destructive manner. For example, a catch can be provided here, which can be released quickly and with low effort for replacement or for inserting such an element variable in length. However, preferably, this catch is formed such that it cannot be released upon normal adjustment and variation of the length of the element, and thus, unintended release can be prevented. However, it can also be provided that in case of such an integral arrangement of an element variable in length, it is screwed on, in particular screwed in a bore in the model head.

Preferably, the system is formed such that length variation and/or adjustment of an active position and/or of a passive position of an element variable in length can be performed automatically. Therein, by an active position, in particular, the completely recessed state of the element variable in length is understood, however, in which a front gripping zone can be gripped by an operator, and thus, the element variable in length can for example be manually extended. By a passive position, the completely recessed arrangement of an element variable in length in the model head is to be understood. Then, advantageously, even the gripping zone cannot be gripped. Such an automatically controlled adjustment of an active position or of a passive position is advantageous especially in systems having a very high number of elements variable in length. In particular, if they are formed rod-shaped and designed telescopically, it can be provided that all of them can be brought into the active position or the passive position at the same time or even temporally shifted with respect to each other. Thereby, the readiness of use of the system can be established very quickly, however, the finishing and tidying up can also be effected very quickly on the other hand. Moreover, thereby, the damage of the elements variable in length can also be substantially reduced. Exactly with very thin elements variable in length, in particular with very thin rods, thereby, folding or bending can be prevented, if else an operator is to manually push a relatively long extended element variable in length into the passive position for example with relatively great force effect. Moreover, for such a manual approach, optionally, higher expenditure of time is required in order to consecutively transfer a plurality of elements variable in length again into the inserted and stored state. The automatic control of these positional adjustments allows this with substantial more time reduction.

In particular, an automatically controlled length adjustment or length variation of an element variable in length can also be provided. Thereby, individually defined or pre-settable lengths of an element variable in length can be autonomously adjusted by the system. For demonstration and training purposes, thereby, the representation of a haircut can be improved over again. In particular, thereby, one and the same haircut can also be exactly represented with the elements variable in length in precise manner and repeatable several times. Thereby, the individual hair lengths can be adjusted comprehensible at all times and a demonstration can be shown quickly and target-aimed correctly.

In particular, the system for automatic control of this positional adjustment and/or these length adjustments can include an electronic controller driving the elements variable in length. For example, they can vary their length via motorized drive units such as an electric motor or the like.

In particular, it can be provided that with such an electronic control, one or more operating elements are provided, which can be operated by an operator. Depending on these operations of the operating elements, then, very different operation steps can be initiated or performed. An operating element such as for example a knob, a rotary/pressure switch, a toggle switch or even a touch screen field can be disposed on the model head.

However, similarly, it can also be provided that the system is operable via a wireless remote control.

Preferably, the system can also include a length measuring element. In particular, this length measuring element can be used for distance measurement of a specific point on the head surface up to a tip of an element variable in length symbolically representing the hair length and projected in an angle of 90 degrees to the head surface. By such a length measuring element, for example, the adjustment of hair lengths in very different head sections can be facilitated for a trainee or an advanced training person and the precision in training the hair length adjustment on the training system can thereby be increased.

The length measuring element can be provided as a separate accessory to the system.

In particular, it is advantageous if the length measuring element is formed flexibly. Thereby, the length measurement can be effected more detailed. For example, a thread element, a wire element or a chain or the like can be provided as the length measuring element.

In particular, it is provided that a length measuring element is associated with each element variable in length. For example, it can be connected to the element variable in length. Attachment of this length measuring element can for example be provided at an outside of the element variable in length.

It proves particularly preferred if a length measuring element is formed integrally with the element variable in length.

Preferably, it can be provided that the length measuring element is disposed at least in certain areas in a hollowly formed element variable in length. In particular, if the element variable in length is formed as a telescopic rod device, it can be formed hollow at least on the front partial element, and the length measuring element can be positioned therein. In particular, then, it can be provided that the length measuring element extends beyond the front tip or the front end of the element variable in length, respectively, and therefore, it is always present ready to hand for an operator. Independent of whether the element variable in length is then actively used or is for example inserted in the model head in the telescoped state, then, the length measuring element can yet be used separately and independently thereof. In particular, if it is formed as a flexible element, it can be extracted from the element variable in length currently not used, and a very precise distance measurement from this element variable in length currently not used up to an outer tip of another element variable in length already adjusted to a specific length can thereby be performed. In particular, thereby, the distance from the head surface at the point, at which the element variable in length joins, up to this tip of the other element variable in length already adjusted to a specific length can be measured.

In particular, in such an integrated configuration between the length measuring element and an element variable in length, thus, the relative and independent movement of the components with respect to each other can be ensured in specific phases of a haircut representation. Besides a compact and highly functional construction, thereby, a configuration reduced in components can also be ensured. Moreover, the required components are always ready to hand and in correct place an do not have to be searched or be attached in target-aimed manner first. Moreover, the length measuring element is also protected from wear and contamination by this configuration.

It can be provided that the length measuring element includes a sort of cable pull device in case of a configuration as a flexible part. Thus, it can be provided that upon extracting the length measuring element by an operator, it is automatically again rolled up upon release. However, it can also be provided that a locking means can be activated in particular upon extraction, by which it can be achieved that the extracted length of the length measuring element does not result in inevitable automatic roll-up even upon release of the length measuring element by the operator. Therefore, an adjusted length of the length measuring element is even maintained if it is released by an operator. For releasing this locking device, for example, it can be provided that a short-time, jerky pull on the length measurement element is performed.

Moreover, preferably, it is also provided that if the length measuring element is not extracted, but the associated element variable in length is extracted by an operator or is automatically extended, then, the length measuring element is also automatically extracted at the same time in unaffected manner. If only the element variable in length is activated or varied in length in this way, thus, it is not impeded by locking or the like by the length measuring element.

Preferably, the system includes an electronic storage unit, in which haircuts recorded or created in simulated manner can be stored. In particular, it can be provided that the respective lengths of the hairs in the individual specific head sections are stored for specific haircuts. Thus, it can be allowed that the lengths of the hairs of a specific stored reference haircut can be displayed. This is then effected by selection of the specific reference hair cut, whereby the individual elements variable in length can then be extended to the stored lengths. The selection of a reference haircut can be effected by operating elements on the model head or via a remote control or another operating means. It can be provided that reference haircuts can again be deleted or that new or additional reference haircuts can be stored, respectively. For this, it can be provided that the individual lengths of the respective elements variable in length in the respective head sections are individually input through the operating elements or a keyboard or in another manner, for example also by voice entry. However, it can also be provided that pictorially acquired lengths of a reference haircut are automatically determined by processing the image data in a computer unit with a suitable software and are stored for the specific haircut.

Both for training and demonstration purposes, thereby, a very fast and precise adjustment of a plurality of elements variable in length can be allowed. Thereby, a three-dimensional representation of the haircut and in particular of the respective hair lengths in the individual head sections can be demonstrated repeatable several times with high precision to very different categories of persons. Thereby too, the learning effect can be increased and precise inspection and comprehension of a haircut several times can be allowed.

In particular, in a fundamentally automatic configuration, it is now also possible that trainees can practice different haircuts on the model system independently and without permanent supervision or without creation of a real reference haircut by an instructor at the same time. Thereby too, the training can be individualized and rendered flexible. It is no longer required that an instructor simultaneously performs a reference haircut on a human head and at the same time a trainee represents this haircut on the model system and specifically adjusts the elements variable in length to this end. Rather, by this automatic realization, independent training can be effected at any time.

Preferably, it can be provided that the elements variable in length, depending on a selected reference hair cut, are automatically adjustable to the associated length controlled by a controller. In this connection, it can be provided that a trainee first adjusts the elements variable in length in the individual head sections with the individual lengths in order to perform the three-dimensional representation of the selected reference haircut thereby. Only if the complete representation by the trainee is completed, then, the automatic adjustment of the individual reference lengths of these elements variable in length with regard to the selected reference haircut can be effected through an operating element or the like. Thereby, the learning effect can be improved over again since it is immediately recognizable at large, at which locations the trainee has deviated from the respective reference lengths.

In particular, it can also be provided that the haircut represented by the trainee is also stored on the model system. For this, it can be provided that the respective extension length of an element variable in length is detected by electronic sensors and stored.

It can also be allowed that by simple operation of an operating element, it can be switched back and forth between the reference haircut and the result achieved by the trainee, and repeat and alternate representation of the differences is often shown in this way. Thus, the difference between the reference haircut and the attempt of the trainee can be switched back and forth several times and in alternately repeating manner, and possible errors in the length adjustment of the elements variable in length can be demonstrated in this way. Thereby too, the learning effect can be improved.

However, similarly, it can also be provided that a mode is set, in which after selecting a stored reference haircut to be represented, an operator adjusts an element variable in length to a certain length and then changes to a comparison mode, in which immediately subsequently the reference length of this element variable in length is then adjusted with respect to the selected reference haircut. The trainee or the training person, respectively, can then immediately recognize if he/she has adjusted the specific element variable in length to a correct length with regard to the reference haircut to be represented.

Moreover, it can also be provided that, for example, a first attempt of a trainee for representing a specific reference haircut, is stored and anytime subsequently in time, a further attempt for this reference haircut is performed. Then, it can also be automatically represented how the two attempts of the trainee differ. Thereby, for example, improvement or positive learning success can be recognized.

For example, an element variable in length can be formed of wood, of metal or even of plastic. In particular, it can also be provided that an element variable in length is transparent to light at least in certain areas. Then, it can be provided that the system has one or more light sources and one or more elements variable in length can be illuminated.

An element variable in length can be formed as a light guide at least in certain areas. For example, light emitting diodes or incandescent lamps can be provided as the light sources. In particular, light sources can be provided, which allow different colorings. Similarly, however, a light source can also be provided, for example a light emitting diode, which is formed for producing different colors of light. Thereby, individual hair colorings can also be represented by the training and demonstration system.

Moreover, an illumination can also be provided to the effect that two different colorings are preset for training purposes. Thus, for example, it can be provided that elements variable in length, which are extended to a correct or substantially correct length with regard to a representation of a reference haircut, can be illuminated green. Elements variable in length, which have been adjusted to an incorrect length, can for example be illuminated red. By this implementation, possible errors or deviations can be indicated even more intuitive and can be better comprehended in the three-dimensional representation for a trainee.

It can also be provided that in an element variable in length, which has at least two partial elements, a separate light source is associated with each partial element, and each partial element can be separately illuminated. By such a configuration, it can be allowed that even only the actually deviating lengths between a reference length and an adjusted length of an element variable in length are identified with color.

It can also be provided that three light emitting diodes are associated with an element variable in length, one of which is formed for producing beams of light with red color or light, a second one for producing beams of light with green color of light, and a third one for producing beams of light with blue color of light. Depending on the respective control of these light emitting diodes, then, any arbitrary color can be produced by color mixing.

Preferably, the system includes an image capturing/image processing system. Thereby, a pictorial capture of reference haircuts can be allowed, which can then be stored and selected for training purposes. Moreover, by such an image capturing/image processing system, a training procedure of a trainee can also be recorded in pictorial manner. Thereby too, error analysis or the like can be rendered more precisely and the learning success can be improved. Not least, thereby too, a training procedure can be recapitulated and comprehended several times. This can also be very advantageous for post-processing purposes.

Preferably, the image capturing/image processing system includes at least one optical detector unit and a computer unit. One or more cameras can be provided as the optical detector unit. In particular, 3D stereo cameras can be encompassed by the system. Thereby, highly precise capture can be allowed, whereby the capture of a reference haircut can also be effected very precisely. In particular, in cooperation with corresponding image processing systems, the three-dimensional representation of a recorded reference haircut can be allowed as a simulation, and thereby, the respective lengths of the hairs of a haircut in the respective positions can be determined. Thereby, the system can virtually independently and automatically determine the respective hair lengths of a reference haircut, which has been recorded.

Preferably, the image processing system is formed for recording videos of procedures for representing haircuts on the model head, wherein the procedures can be stored.

Preferably, the system can be formed for comparison analysis of a hair cutting procedure performed on a real head with a procedure for representing this hair cutting procedure on the model head.

It proves preferred if with such an automatic control of the length adjustment of an element variable in length, the respective elements variable in length are consecutively adjusted individually in the intended order of the real hair cutting procedure. In particular for demonstration purposes, thus, it can not only be demonstrated to a trainee or an advanced training person, which respective lengths are to be adjusted for a specific haircut, but also in which order the elements variable in length disposed locally distributed on the head surface are adjustable in their length. Thereby, it can be comprehended automatically and in self-learning manner, in which head sections consecutively the respective hairs have to be adjusted or really cut to the individual length with regard to the selected reference haircut, respectively.

A model head can include an integrated display unit, for example a display or a screen, which especially is movable relatively to the model head. For example, the display unit can be attached to the model head by means of a swiveling mechanism. Thereby, the display unit can be moved into any position in order to be able to display and appropriately view stored reference haircuts or hair cutting procedures. If this display unit is not required, it can be swiveled in and positioned on or in the model head in space saving manner.

Similarly, it can be provided that a separate display unit is directly electrically connected to the model head.

A further aspect of the invention relates to a system for three-dimensional representation of a haircut with an artificial model head modeled on the human head, and a plurality of rod-shaped elements for symbolic representation of hair lengths. By such a system, the symbolic representation of a haircut can be substantially rendered more precisely and the number of the elements can be disposed substantially denser due to the relatively thin rod shape thereof. Thereby, a structural representation of a haircut can be effected substantially more exactly.

Preferably, a rod-shaped element can be insertable into the model head with individual length. Thereby, a plurality of elements of substantially equal length can be inserted into the model head with different insertion depth. Thereby, in locally different zones of the model head, rod-shaped elements can be disposed, which protrude from the model head with different lengths. With a plurality of substantially equal elements, thereby, different length structures for symbolic representation of hair lengths can be allowed.

Advantageous developments of the system according to the first aspect of the invention are to be considered as advantageous development of the system according to the second aspect of the invention.

A system can also be formed and referred to as a device.

Preferably, the model head is formed such that a volume part delimited by the surface area corresponding to the hairiness is detachably connected to the remaining part of the model head. Thereby, exchange of this partial element of the model head can be allowed. In particular, thereby, different head shapes or different implementations with regard to the attachment of the elements variable in length can be allowed. Since due to the plurality of different haircuts, different embodiments of the system optionally can also each be advantageous, by such a configuration with high flexibility, compatibility and modularity with regard to a best possible representation or demonstration of a haircut, the optimum system components can be provided.

In particular, any combination of the different embodiments of the system can also be allowed. Thus, for example, it can be provided that a plurality of elements variable in length is integrally formed on a model head, however, partial regions of the head are also provided for individual insertion of further elements variable in length. Thereby, in specific regions of the model head, the density of elements variable in length can optionally be increased and thereby, the precision of the structural representation can be refined.

A further aspect of the invention relates to an element for symbolic representation of a hair length, which is formed variable in length. In particular, the element is formed reversibly variable in length.

Preferably, it can have at least two partial elements connected to each other and movable relatively to each other especially in the longitudinal direction of the element. Thus, for example, a telescopic device can be provided. However, a detachable connection between the partial elements can also be provided, which can then for example be realized as a plug device.

In particular, the element variable in length is formed resistant to bending.

It can also be provided that the element variable in length is formed for continuous length variation.

However, similarly, it can also be provided that this length variation of the element is only provided in discrete manner and thus in steps.

In particular, it is also possible that the element variable in length is formed in one piece and the at least two partial elements are not reversibly movable relatively to each other for length variation, but are separable from each other by predetermined breaking points. Thereby too, the length variation of the element can be allowed, but only in irreversible manner.

Preferably, the element has an outer diameter, which is smaller than or equal to 7 mm, in particular smaller than or equal to 5 mm, especially smaller than or equal to 3 mm.

By this dimensioning, a plurality of elements variable in length can be attached to a model head, and thereby, the precision of a three-dimensional haircut representation can be substantially increased.

Preferably, the element variable in length is formed as a hollow body at least in certain areas. In particular, it is designed tubular at least in certain areas. Thereby, a relatively light element reduced in weight can be allowed, which moreover can also be realized relatively low-cost.

Moreover, it can be provided that a length measuring element is formed on or in the element variable in length. In particular, if it is formed hollow at least in certain areas, the length measuring element can be disposed in the hollow region. Preferably, the length measuring element is movable relatively to the element variable in length or a partial element thereof.

A further aspect of the invention relates to a method for three-dimensional representation of a haircut, in which elements variable in length on a model head are adjusted to a length, which corresponds to a hair length of hair of the specific haircut to be represented in this local place of the head.

In particular, it is preferably provided that the elements variable in length can be varied in length in the direction of their longitudinal axis and be adjusted accordingly. Preferably, the elements variable in length are disposed substantially perpendicularly to the head surface and are adjusted to the desired length.

Preferably, the elements variable in length are adjusted stepless and thus continuously to the individual length of the symbolic representation of a hair length of the haircut to be represented.

It can also be provided that the lengths are only adjusted to a corresponding length in steps and thus not continuously.

Advantageous developments of the previously mentioned aspects of the invention concerning the systems and the element are to be considered as advantageous developments of the method according to the invention. In particular, the approaches for automatically adjusting lengths of the elements variable in length as well as the automatic adjustment and selection as well as storage of reference haircuts with the respective reference lengths are to be considered as advantageous method steps. Moreover, the pictorial acquisitions of reference haircuts as well as the representation and demonstration of reference haircuts and hair cutting procedures as image information via a display unit are to be considered as advantageous method steps.

The process flows according to the invention or advantageous implementations thereof can also be defined by a computer program. It can be stored on a data storage and be provided for flow control. Preferably, the computer program can also be formed for simulating a haircut and/or a hair cutting procedure and/or for processing recorded image data.

In principle, therefore, not only a system, an element and a method for internal training and advanced training for trainees and the like can be provided by the invention, but also a presentation and demonstration system for workshops, instructions and other presentations or the like can be provided. In particular, the system and the approach can also be used for examination purposes, and thereby a substantial advantage can be realized. Especially the documentation and the reconstruction of examination questions in the practical area can be documented thereby.

### BRIEF DESCRIPTION OF THE DRAWINGS

Below, embodiments of the invention are explained in more detail based on schematic drawings. There show:

FIG. 1 a schematic side view of a human head;

FIG. 2 a perspective illustration of a first embodiment of a system according to the invention;

FIG. 3 a schematic top view of the implementation according to FIG. 2;

FIG. 4 a schematic side view of a further embodiment of a system according to the invention;

FIG. 5 a schematic side view of a third embodiment of a system according to the invention;

FIG. 6 a fourth embodiment of a system according to the invention in a schematic side view;

FIG. 7 a first embodiment of an element for symbolic representation of a hair length;

FIG. 8 a second embodiment of such an element in a schematic side view;

FIG. 9 a third embodiment of such an element in schematic side view;

FIG. 10 a fourth embodiment of such an element in schematic side view;

FIG. 11 a fifth embodiment of such an element in schematic side view;

FIG. 12 a sixth embodiment of such an element in a schematic exploded illustration; and

FIG. 13 a schematic illustration of a further embodiment of a system according to the invention.

### PREFERRED IMPLEMENTATION OF THE INVENTION

In the figures, similar or functionally similar elements are provided with the same reference characters.

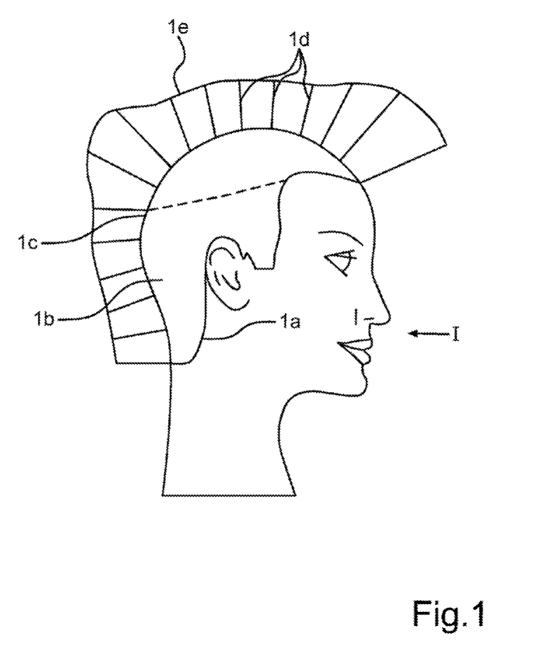

In FIG. 1, in schematic manner, a side view of a human head I is shown. An outline 1a drawn exemplarily delimits a head region, which is covered with head hair. This head region 1b is delimited by a head surface 1c due to the head curvature. Hairs 1d extend from it outwards.

For hairdressers it is important to be able to imagine the structure of a haircut to be cut. Therein, by a structure, the length arrangement of the hairs in the region 1b across the head curvature is understood, if each hair protrudes in the angle of 90 degrees away from the head surface 1c. This is exemplarily shown in FIG. 1, in which the hairs 1d are each disposed perpendicularly to the surface 1c. In the side view according to FIG. 1, only the line 1e of the structure is shown, which is formed as the connection between the ends of the hairs 1d facing away from the head surface 1c. In the three-dimensional representation, the structure 1e also represents a surface, which can have very different shape contours depending on the haircut. In particular, it is generally different or highly different from the shaping of the surface 1c defined by the scalp.

Depending of the haircut to be made individually, respectively, thus, the length of the individual hairs 1d in the local positions of the surface 1c is also different.

In particular, for a hairdresser and especially for trainees or advanced training persons in the hairdressing profession, it is important to be able to imagine this structure 1e of a haircut in three-dimensional manner. If, for example, the hairs 1d illustrated in FIG. 1 in the upper head region, are cut to a length specific to the selected haircut, thus, it is important that the hairdresser is able to also imagine at the same time, which length the hairs, for example near the ear, have to have in order to be able to make the desired haircut. In this respect, thus, in cutting the hairs 1d in a specific first position of the region 1b, one has to be able to imagine at the same time, which length or how the projected hairs has/have to be cut in a second position in the region 1b.

Often, this is very difficult and associated with considerable training effort in particular for trainees or even for advanced training persons.

Especially this learning, but also advanced training in this respect, is substantially improved by the invention. The learning can be effected more effectively and more efficiently, and comprehension can also be allowed. In particular, a substantially improved symbolic representation of a haircut and especially of the respective hair lengths in the individual head sections can be ensured by the invention, whereby the learning can be optimized and the learning success also arrives more quickly. Moreover, the more precise and more detailed representation also trains the better imaginative power, whereby one can also better memorize the individual haircuts.

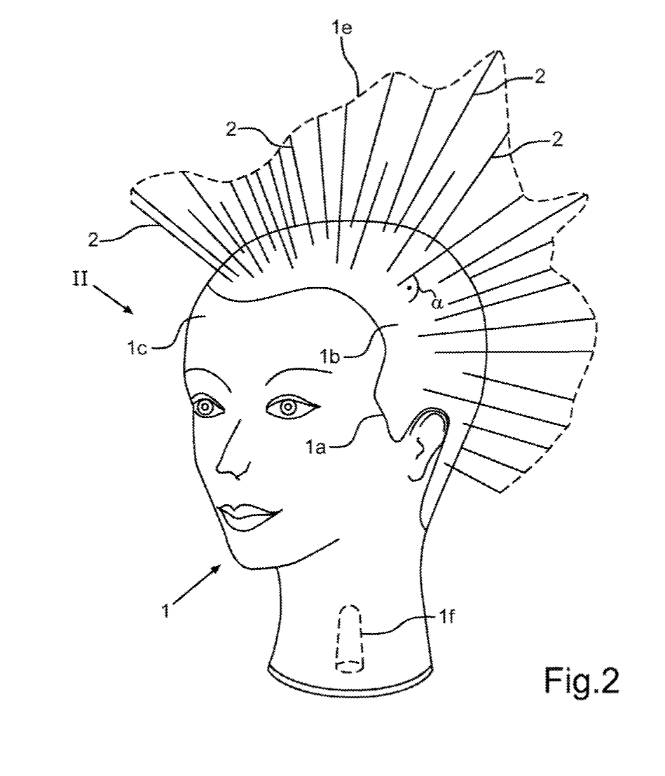

In FIG. 2, in schematic illustration, a first embodiment of a system according to the invention for three-dimensional representation of a haircut is shown.

The system II includes an artificial model head 1 modeled on a human head, on which an outline 1a is illustrated on a head surface 1c. Moreover, a surface region 1b is formed, which usually is provided with hairiness in case of a human head. In the system II, in the surface region 1b, a plurality of elements 2 variable in length are disposed, which are schematically illustrated in FIG. 2. The elements 2 variable in length are formed rod-shaped and disposed on the model head 1 such that they are disposed substantially perpendicularly to the head surface 1c in the respective position, as it is indicated by the angle α.

In the exemplary illustration according to FIG. 2, the individual elements 2 variable in length are disposed with very different lengths such that a relatively complex shaping of a structure 1e is formed as the surface shape.

For example, the elements 2 variable in length can be formed of wood, of metal, of plastic or the like. In particular, these rod-shaped elements 2 variable in length are formed resistant to bending, which means that they virtually perpendicularly project from the head surface 1c to the outside even in an arrangement in the neck region or on the back of the head.

It can be provided that in particular that partial region of the model head 1, which is constituted or delimited by the surface 1b and the outline 1a, respectively, can be removed from the remaining model head 1 as a volume body part. By this configuration, it can be allowed that manifold configurations and shapings of such a partial region can be inserted into the model head 1. In this respect, the system II and in particular the model head 1 can be optimally assembled depending on situation and need with regard to the use, employment and detailed representation. Thereby, it can also be achieved that for example a used up or worn partial element, on which the elements 2 variable in length are disposed or can be disposed, can be replaced in relatively inexpensive manner since it is not the entire model head 1, which is not usable anymore, but only this specific part thereof. Moreover, the modular construction ensures high flexibility of the system II.

The elements 2 variable in length can be disposed on the model head 1 in integrated manner and thus be fixedly attached thereto. In particular, such an integral attachment of the elements 2 variable in length can be provided such that only removal due to wear or for repair or the like can be effected. Such a removal is preferably formed such that it yet requires specific assembly steps to be performed deliberately, in order to then be able to remove an element 2 variable in length. Otherwise, for the conventional employment and purpose of use of an element variable in length with an integral configuration, a non-releasable connection is effectively designated.

However, naturally, it can also be provided that the element 2 variable in length is integrated in the model head 1 such that even deliberate removal for repair or replacement purposes is not possible.

However, similarly, it can also be provided that an element variable in length is completely formed as a separate part, and can be individually attached to the surface 1c in the region 1b for representing symbolic hair lengths. In particular, therein, an attachment by means of magnets, a Velcro tape with an inverse hook-and-loop system or the like can for example be provided. Similarly, it can also be provided that in particular the partial element of the model head 1, which is delimited in area by the outline 1a and the surface region 1b, is formed of a material composition, which allows the insertion of separately formed elements 2 variable in length. For example, styrofoam, foamed plastic or a suitable modeling mass can be provided here. In particular, the material is formed such that upon insertion and subsequent extraction of the element 2 variable in length, the hole arising thereby is automatically closed again.

In an integral arrangement of the elements variable in length, the number per unit of area can be uniformly distributed across the entire surface 1b. However, it can also be provided that the number of elements 2 variable in length per unit of area locally varies in the surface region 1b.

Similarly, it can also be provided that an integral arrangement of elements 2 variable in length is provided, and additionally, separate elements 2 variable in length for detachable attachment are provided in the surface region 1b. Thereby, the number of present elements 2 variable in length can be varied depending on situation, and moreover, the individual positioning of individual elements 2 variable in length can be specifically configured. Thereby, the flexibility of the system II can be substantially increased over again and advantageously be provided for very specific haircut representations.

In the neck region of the model head 1, a recess 1f is formed, into which a retaining element or an assembly device can be introduced, and thus the model head 1 can be set up.

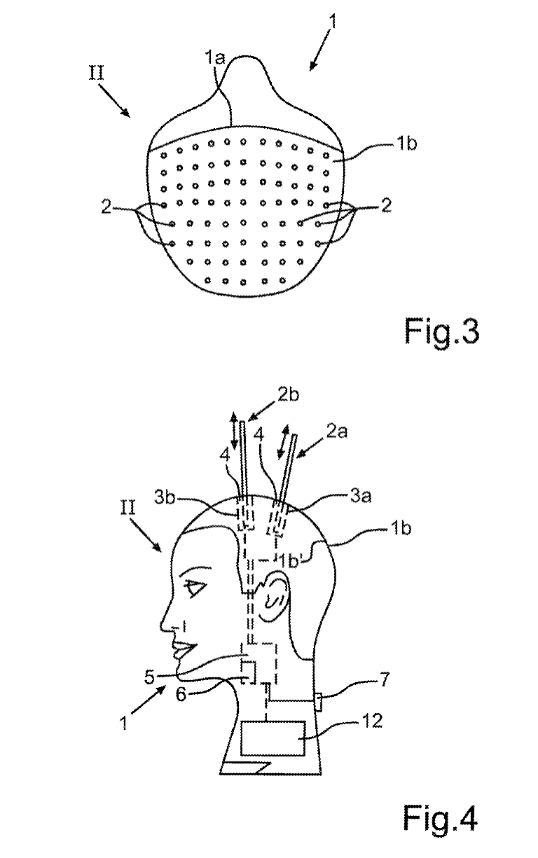

In FIG. 3, a schematic top view of the system II according to FIG. 2 is shown. It is appreciated that the plurality of elements 2 variable in length are disposed distributed across the surface region 1b. The schematic illustration shows a situation, in which the elements 2 are all substantially completely recessed in the model head 1 and the system II therefore is in the non-used state. Especially with automatic elements 2 variable in length or with telescopic implementations of the elements 2 variable in length, they are then completely disposed in a passive position and thus recessed.

In FIG. 4, in a lateral illustration, a further embodiment of a system II is shown, in which only the two elements 2a and 2b variable in length are shown on the training head or model head 1, respectively, representative to a plurality of further elements variable in length. The two elements 2a and 2b variable in length are equally formed with respect to their basic configuration. In this implementation, it is provided that the elements 2a and 2b variable in length are connected to the model head 1 in non-detachable and thus integral manner. In the shown implementation, it is provided that bores 3a and 3b are formed in the model head 1 in the region of the attachment of the elements 2a and 2b variable in length, in which these elements 2a and 2b are disposed. In the embodiment, the model head 1 can be formed solid, and the bores 3a and 3b can be formed location-specific. Thereby, it can be provided that the elements 2a and 2b variable in length can be extended or contracted in the direction of their longitudinal axis (in arrow directions), respectively. In FIG. 4, it is exemplarily shown that the element 2b variable in length is completely extended and thus represented over its maximum length. However, in contrast, the further element 2a variable in length, which has a maximum length corresponding to the element 2b variable in length, is only extended over a smaller length. In the completely contracted state, the elements 2a and 2b variable in length are substantially completely recessed in the bores 3a and 3b, respectively. Only a minimum projection with respect to the surface 1b can be provided such that the elements 2a and 2b variable in length can be gripped by an operator or a user, respectively, and be manually extended to a desired length.

It can be provided that a cleaning element 4 is attached to the upper edge of a bore 3a or 3b, respectively. For example, it can be formed brush-like. However, similarly, a fabric, for example non-woven fabric, can also be provided, by which the exterior of the elements 2a and 2b can be cleaned upon extraction or insertion, respectively. In particular in case of materials, which can be contaminated by gripping, thereby, reliable cleaning can be allowed. Especially in case of shiny materials or coatings, this is advantageous since fingermarks or dust can automatically be wiped off thereby, and thus, shiny and high-quality impression is allowed all the time.

Instead of a solid formation of the model head 1 and in particular of the volume part, which is outwards delimited by the outline 1a and the surface area 1b, it can also be provided that especially this three-dimensional partial element is formed hollow inside. The elements 2a and 2b variable in length can then be disposed protruding into this cavity corresponding to the exemplary illustration in FIG. 4.

In such a configuration, it can be provided that the elements 2a and 2b variable in length are detachably attached to the inner side and thus to the area 1b' facing the surface region 1b. Thereby, the undesired detachment upon length variation of an element 2a or 2b is prevented on the one hand, however, the exchange of an element 2a and 2b for repair purposes or the like is ensured on the other hand. It can be provided that an element 2a or 2b variable in length, respectively, is screwed, locked or secured by magnets or the like on this inner side, respectively.

However, it can also be provided that the bores 3a and 3b have female threads, into which the elements 2a and 2b can be screwed for semi-integral attachment. For this purpose, an element 2a and 2b has a corresponding male thread at the outside.

In particular, it can be provided that the length variation of an element 2a and 2b variable in length can be performed exclusively by manual operation, in particular by extraction or insertion of an element 2a or 2b by a user, respectively.

However, it can also be provided that the elements 2a and 2b variable in length can be automatically controlled. For this purpose, it can be provided that the system II has an electronic controller 5, which is preferably disposed in the model head 1 in the shown implementation. Naturally, this controller 5 can also be disposed in another position on the model head 1 or even externally thereto. The controller 5 includes an electronic storage 6, however, which can also be disposed as a separate unit.

The controller 5 is electrically connected to an operating element 7, which is disposed at the outside in the neck region of the model head 1 in the embodiment. The operating element 7 can be a single operating element. It can be provided that the operating element 7 is a toggle switch, a rotary switch, a press button or a rotary/pressure switch. Similarly, it can be provided that the operating element 7 is a touch screen or the like. Moreover, it can also be provided that plural operating elements 7 are provided.

In such an automatically controlled implementation, it can be provided that by operating the operating element 7 starting from a completely deactivated state of the system II, in which all of the elements 2 or 2a and 2b, respectively, are in the completely recessed state, extension can be performed. By operating this operating element 7, for example, it can then be allowed that at least some, in particular all of the integrally disposed rod-shaped elements 2a and 2b are extended into an active position. This means that they are only minimally extended and thus are transferred from the completely recessed and non-grippable state into a positional state, in which they only minimally protrude beyond the surface region 1b and thus subsequently can be gripped by a user for further manual extraction. If, in the following, a user has terminated a training procedure, and the elements 2a and 2b variable in length (mentioned representative to a plurality of further elements 2 variable in length) extended to individual lengths are again to be transferred into the deactivated state and thus the completely recessed state, in this way, this can be achieved particularly quickly and efficiently in that the operating element 7 is operated. Thereby, all of the individually extended elements 2a and 2b variable in length are transferred into the completely recessed state in particular in automatic manner and in particular at the same time. Thereby, compared to manual insertion of all individual elements 2a and 2b, a substantial advantage in time in clearance can be achieved, and moreover, the risk of damage can be reduced. In particular with very thin elements 2a and 2b variable in length, which moreover are additionally extended substantially over the maximum length, in case of inadvertent or fast manual insertion, damage by deflection or the like can occur. By the automatically controlled transfer into such a passive position, this can be avoided. In addition to an automatic adjustment merely of basic positions, moreover, it can also be allowed that automatically controlled adjustment of individual lengths of the individual elements 2a and 2b variable in length is allowed. For example, it can be provided that at least one reference haircut is stored in the storage unit 6. By operating the operating element 7, then, the individual elements 2a and 2b variable in length can be extended in projection to the lengths required for the reference haircut to be represented for symbolic representation of the local hair lengths. In particular for training for demonstration purposes, thereby, the representation of the respective hair lengths in the specific local positions can be allowed symbolically in very fast manner and with high precision.

It can also be provided that a plurality of reference haircuts is stored in the storage unit 6 and selection of a specific reference hair cut can be effected by individual operation of one or more operating elements 7, and then it can be represented by automatic extension of the respective elements 2a and 2b variable in length.

However, moreover, it can also be provided that at least some, in particular all of the elements 2a and 2b variable in length are equipped with one or more sensors, which are able to detect an adjusted length of an element 2a and 2b, respectively. These detected lengths can then be transferred to the controller 5 as information. In particular, it can also be provided that these values are then individually stored.

However, similarly, it can also be provided that storage of this detected length information is only effected if an operating element 7 is operated by a user. By such an implementation, it can be allowed that a person training with the system II first completely attempts to represent a haircut, and manually adjusts the present elements 2a and 2b variable in length to the specific lengths for this purpose. If all of the elements 2a and 2b variable in length are extended or adjusted to a corresponding length, respectively, by operating the operating element 7, these adjusted lengths can be stored. Thus, it is allowed that the attempt performed by a training person, to represent a reference haircut and to display the corresponding hair lengths symbolically by the elements 2a and 2b variable in length for this purpose, can be stored as a whole. Then, the extension length detected through the sensors is detected from each individual element 2a and 2b variable in length and stored.

Thus, subsequently, the attempt performed by the training person can be reconstructed and comprehended over again. Similarly, it can also be provided that a comparison between the attempt that the training person has made, and the reference haircut is then possible, by first automatically showing the reference haircut by corresponding extension of the elements 2a and 2b variable in length, and then subsequently showing the stored attempt of the training person, by automatically adjusting the lengths of the elements 2a and 2b stored in this respect. This can then be repeated any number of times, whereby the learning effect and the comprehension of possible errors can be effected substantially more intuitive and comprehensible. Moreover, thereby, it can also be achieved that the training on the one hand, the review and improvement on the other hand, and the repeat comprehensible at all times afterwards are allowed at any times situated independently of each other.

Moreover, it can also be provided that the automatic extension of the elements 2a and 2b variable in length for demonstration of the reference haircut is effected according to a preferred order. In particular, therein, it is provided that the order is preset as it is also effected in actual real hair cutting in the individual head sections. Specific to haircut, then, the individual elements 2a and 2b variable in length are extended consecutively in the respective positions in the order correct with respect to the selected haircut and adjusted to the respectively correct length. Then, in addition to the correct length, at the same time, the correct order in cutting the individual hair sections for creating the reference haircut can be demonstrated to the training person.

Similarly, it can also be provided that it can be detected by the sensors, in which order the individual elements 2a and 2b variable in length have been extended one after the other, or optionally have yet been corrected afterwards. Thereby too, it can then be allowed that in the following total storage and comprehension of the attempt of the training person, not only the respectively adjusted lengths of the elements 2a and 2b, but also the order, when the individual elements 2a and 2b have been extended, can be comprehended.

In the shown implementation according to FIG. 4, the electrical connection between an element 2a and 2b variable in length and the controller 5 as well as between the controller 5 and the operating element 5 is formed wired. However, similarly, it can also be provided that these electrical connections are formed wirelessly. Furthermore, it can be provided that the operating element 7 can communicate with a further unit, for example a remote control, for wireless communication, and a preferably bi-directional data exchange is possible.

In an electronically controlled implementation for extension and retraction of the elements 2a and 2b variable in length, it can be provided that the elements 2a and 2b each have a motorized drive unit, for example an electric motor or the like. It can be driven through the controller 5.

In addition to an already explained releasable catch on the inner side 1d′, in case of a solid formation of the model head 1, it can also be provided that the catch is provided upon insertion of an element 2a and 2b variable in length into a bore 3a or 3b, respectively. The catch is provided such that upon length variation and thus upon extraction or insertion of an element 2a or 2b variable in length, respectively, the entire detachment of such an element 2a or 2b, respectively, from the model head 1 is not possible. For complete removal and release of this external catch, it is preferably provided that locking elements grippable from outside or releasable with an ancillary tool can be released, and then an element 2a or 2b variable in length, respectively, can be separated and removed from the model head 1.

Preferably, the model head 1 has an integrated display unit 12, which preferably is movable relatively to the model head 1. For this purpose, a mechanism can be provided, which allows swiveling in at least one spatial direction. Thereby, the display unit 12 can be set up in any suitable position and be disposed for optimum view. Presented image information such as videos or image sequences can then be observed by a user or other viewer. In particular a training person can then follow the representation of a stored reference haircut selected for training and perform the training on the model head 1 at the same time. The display unit 12 is electrically connected to the controller 5.

The display unit 12 can also be disposed as a separate component to the model head 1 and be immediately electrically connected to the model head 1. Thereby, representation of image information can preferably be allowed on a larger display unit 12.

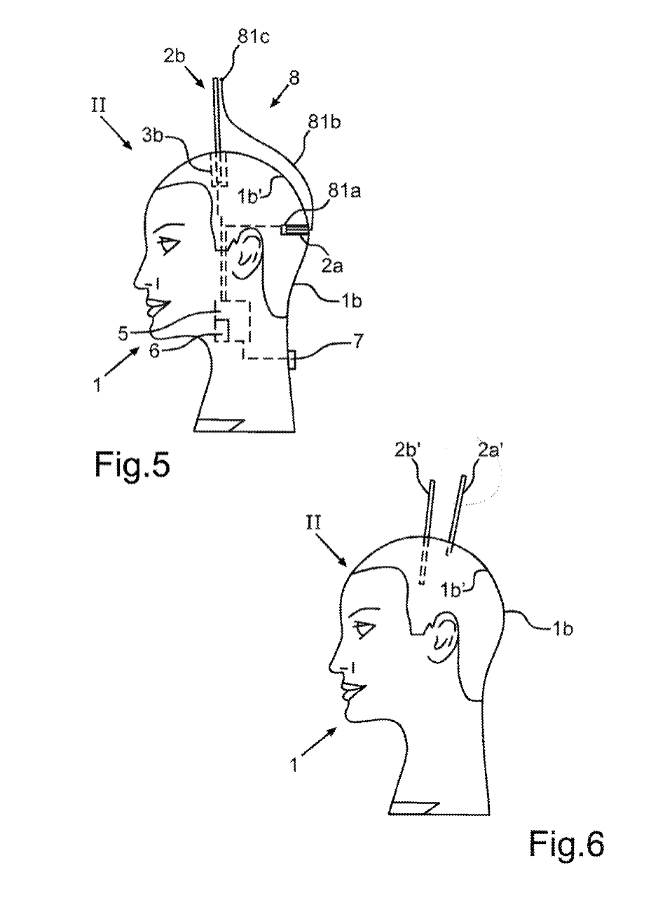

In FIG. 5, a further embodiment of a system II including a model head 1 is shown. In this implementation, at least one of the elements 2a and 2b variable in length, which again are shown representative to a plurality of further elements variable in length, not illustrated, additionally includes a length measuring element 8. This length measuring element 8 allows the measurement of a distance between an element 2a variable in length not yet extended and a tip of an element 2b variable in length already adjusted to an individual length. Thereby, the distance from the head surface at the location of the element 2a variable in length to the tip of the element 2b variable in length can be determined. This approach is important for specific haircuts since the element 2a variable in length is then also manually extracted or automatically extended to a length corresponding to this distance, respectively, depending on this measured length.

Preferably, this length measuring element 8 includes a flexible part, which is realized as a thread 81b in the embodiment, which is disposed on a reel 81a. At the front end of the thread 81b, a gripping element 81c, for example a small ball or the like, is attached, by which the thread 81b can be easily and simply gripped and thus also be easily extracted. In the shown embodiment, it is in particular provided that the reel 81a is disposed in the model head 1. Preferably, it is provided that this reel 81a is disposed on or in the element 2a variable in length and the thread 81b is positioned in the element 2a variable in length, which is then preferably formed entirely hollow, in a manner guided inside. Preferably, the gripping element 81c is dimensioned so large that it abuts the front opening of the hollow element 2a variable in length and cannot slip-through inwards.

Preferably, the reel 81a is formed for automatically rolling up and unrolling the thread 81b. This means that if only the element 2a variable in length is extended and adjusted to a specific length (manually or automatically), this is not prevented by the thread 81b. If the element 2a variable in length is then again contracted and in particular transferred into the completely recessed state in the model head 1, the reel 81a is formed for automatically rolling up the thread 81b. Automatically with the insertion of the element 2a variable in length, then, the thread 81b preferably is also rolled up on the reel 81a at the same time. Thereby, hanging-down of the thread 81b can be prevented, whereby low wear as well as high-quality impression can also be achieved in addition to high functionality.

Similarly, it can be provided that if only the length measuring element 8 is used and the thread 81b is to be extracted separately in order to perform distance measurement, this is also ensured. In this connection, it can be provided that upon manually gripping the gripping element 81c and manually extracting the thread 81b, a locking mechanism is provided, which then does not again automatically and immediately roll up this thread 81b on the reel 81a upon releasing the thread 81b or the gripping element 81c, respectively. The extracted length of the thread 81a then is maintained even upon release of the gripping element 81c. This is particularly advantageous if a measured length has been determined with the thread 81b, and subsequently, the element 2a variable in length then is for example manually to be extracted to this specific length. Thereby, this individual length of the element 2a can be adjusted in defined manner, which then is also allowed with very low effort and in precise manner.

In order to be able to achieve again the roll-up of the thread 81b with such a configuration, this locking mechanism can for example be released by a slight jerky pull on the thread 81b, and thereby the possibility of automatic roll-up on the reel 81a can be activated again.

A flexible configuration proves particularly preferred in the length measuring element 8 since even with elements 2a and 2b variable in length, which are positioned very differently and relatively far away from each other, a relatively precise distance measurement between desired points can thereby be allowed.

The length measuring element 8 can also be formed as a part separate from the element 2 variable in length. Then, it can be provided that the system II has only one such length measuring element 8. This can be configured both flexible and rigid.

In FIG. 6, in a further schematic side view, a further embodiment of a system II for three-dimensional representation of haircuts is shown. In this implementation, the elements 2a′ and 2b′ variable in length are formed as separate parts to the model head 1. Here too, these elements 2a′ and 2b′ variable in length are formed resistant to bending and designed rod-shaped. For symbolic representation of the individual hair lengths, the rod-shaped elements 2a′ and 2b′ variable in length are individually inserted or plugged on the model head 1 in the respective positions by an operator. Therein, the insertion can be effected into pre-fabricated holes. Similarly, it can also be provided that the model head 1, in particular the partial element including the surface region 1b, is formed of a material, into which the elements 2a′ or 2b′, respectively, can be inserted or can be detachably attached to this surface 1b. For example, this can be provided with magnets or the like.

Here too, the elements 2a′ and 2b′, respectively, can be formed for continuous or discrete length variation. For example, telescopic configurations of elements with predetermined breaking points can be provided. However, it can also be provided that the rod-shaped elements 2a′ and 2b′ are formed in one piece and are attachable to the model head 1 with different insertion depths, and thus the lengths protruding from the model head 1 are individually adjustable for symbolic representation of the hair lengths.

The various implementations in FIGS. 2 to 6 can be combined in partial aspects or even completely in any manner.

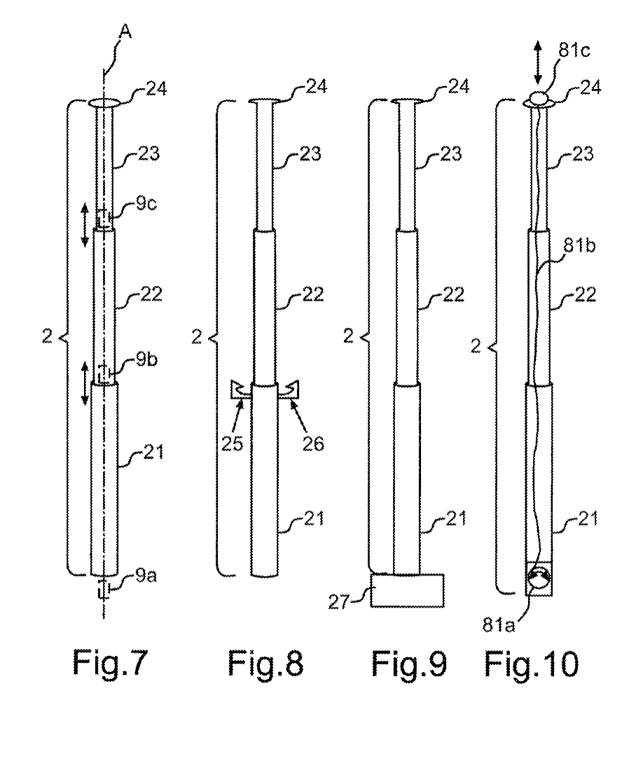

In FIG. 7, in a schematic illustration, a first embodiment of an element 2 for symbolic representation of hair lengths is shown. The element 2 is formed variable in length and exemplarily includes three partial elements 21, 22 and 23, which are movable relatively to each other in the longitudinal axis direction A. In the shown implementation, the element 2 is formed resistant to bending and designed as a telescopic device. At the front end of the third partial element 23, a gripping part 24 is formed, whereby the secure manual gripping by an operator is allowed and manual extension and contraction is ensured. Both the number and the respective individual lengths of the partial elements 21 to 23 of the element 2 are merely exemplary and can vary in manifold manner.

Moreover, it can be provided that the element 2 is formed of a material transparent to light at least in certain areas. Thereby, a partial element 21 to 23 or the entire element 2 can be illuminated with a specific color. By this implementation, individual hair colorings can be represented.

However, thereby, it can also be allowed that errors compared to reference haircuts can be represented for training persons.

It can be provided that a single light source 9a is associated with an entire element 2. For example, it can be disposed at the lower end spaced from or immediately abutting the partial element 21. Similarly, it can be provided that the light source 9a, at least in certain areas, is disposed within the partial element 21, which is then preferably formed hollow at least in certain areas.

It can also be provided that in addition to or instead of this, a light source 9b is disposed in the second partial element 22, and in addition to or instead of this, a light source 9c is disposed in the third partial element 23. Thereby, the individual partial elements 21 to 23 can be illuminated individually and independently of each other with specific colorings. Preferably, it is provided that a light source 9a to 9c is formed as a light emitting diode or as an incandescent lamp. Light emitting diodes are particularly preferred since they can be arranged relatively space saving, and moreover can generate very different colors of light. In particular, it can be provided that three light emitting diodes are respectively associated with an element 2 or with each partial element 21 to 23, and one thereof is formed for generating beams of light with red color of light, a second one for generating beams of light with blue color of light, and a third one for generating beams of light with green color of light. By individual control of these light emitting diodes, by color mixing, any arbitrary colored illumination of the element 2 or of a partial element 21 to 23 can then be achieved.

By the telescopic device of an element 2 shown in FIG. 7, a continuous or stepless length variation can be adjusted, respectively. It can also be provided that the partial elements 21 to 23 are not movable for continuous length variation, but can only be adjusted in discrete steps.

In FIG. 8, a further implementation of an element 2 is shown, in which in distinction from the illustration according to FIG. 7, only one embodiment for a catch on the model head 1 is illustrated. Thus, it can be provided that one, in particular plural locking elements 25 and 26 are formed on the upper section of the first partial element 21. In particular, this first partial element 21 is then disposed in the interior of the model head 1 and the locking elements 25 and 26 are lockable on the inside 1b' (for example FIG. 4).

In FIG. 9, a further configuration of an element 2 is shown, which exemplarily has three partial elements 21 to 23. In this implementation according to FIG. 9, at the lower end of the partial element 21 an electric motor 27 is disposed schematically and symbolically, which can be driven through the controller 5, and thereby the automatic adjustment of the length of the element 2 can be effected.

Moreover, in FIG. 10, a further implementation of an element 2 variable in length is shown, as it was already explained to the implementation in FIG. 5. The length measuring element 8 including the reel 81a, the thread 81b and the gripping element 81c, is disposed integrated in this element 2.

In all of the implementations of the elements 2 according to FIGS. 7 to 10, the number of the partial elements 21 to 23 is merely exemplary. Moreover, any combination of several of the implementations according to FIG. 7 to FIG. 10 can also be provided. In FIG. 7 to FIG. 10, the elements 2 variable in length are illustrated with substantially maximum length and thus effectively completely extended. In the completely contracted state, the elements 2 have a length insignificantly larger than the length of the first partial element 21.

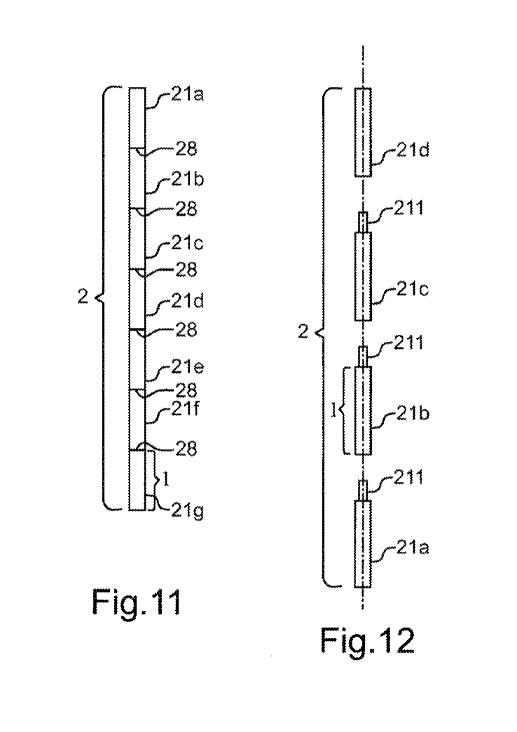

In FIG. 11, a further embodiment of an element 2 is shown, which is formed rod-shaped and variable in length. In distinction from the illustration of the elements 2 in FIGS. 7 to 10, which are reversibly variable in length, this element 2 according to FIG. 11 is exclusively irreversibly variable in length. For this purpose, the element 2 includes at least two, in particular a plurality of partial elements 21a, 21b, 21c, 21d, 21e, 21f and 21g, which are connected to each other via predefined and preferably marked predetermined separating points, in particular predetermined breaking points 28, and therefore, first, a one-part element 2 with fixed total length is provided.

The partial elements 21a to 21g can all have substantially the same length l. However, it can also be provided that they have different lengths. In particular, it can be provided that a partial element with a first length, then a partial element with a second length and subsequent thereto again a partial element with a first length etc. are formed in alternating manner.

Preferably, in such a configuration of an element 2 according to FIG. 11, it is intended that it is provided as a separate part to the model head 1 and is manually inserted into the model head 1 or fitted or attached thereto, respectively. By separating one or more of the partial elements 21a to 21g by separating at the respective predetermined breaking points 28, individual length for symbolic representation of a hair length can be produced, and the element 2 then available in this way can be attached to the model head 1 in a specific position in the surface region 1b.

In FIG. 12, a further embodiment of an element 2 is shown, which is also formed rod-shaped and is reversibly variable in length. In this implementation, according to the exploded illustration in FIG. 12, it can be recognized that individual partial elements 21a to 21d can be plugged together according to a plug device. For this purpose, partial elements 21a to 21c each have a lug 211, which can be inserted into a corresponding recess or bore of a partial element 21a to 21d, respectively. Here too, it can be provided that the lengths l of the partial elements 21a to 21d are all formed similarly. However, similarly, it is also possible that a plurality of different partial elements 21a to 21d with a plurality of different lengths l can be provided. Thereby too, a relatively high number of different formable total lengths of an element 2 can be allowed. It can be provided that an element 2 according to the implementation in FIG. 12 is provided as a completely separate part and also can be attached by fitting or inserting into the model head 1.

However, it can also be provided that a plurality of lugs 211 are integrally formed on the surface 1b, on which one or more partial elements 21a to 21d can then be fitted. In particular, it is provided that preferably a partial element 21d according to the illustration in FIG. 12 is attacked as the termination of an element 2. It does not have any lug 211 and therefore constitutes a termination in due form at the outer end of the element 2.

The implementations according to FIG. 11 and FIG. 12 show elements 2, which have substantially the same diameter over their total length.

Thus, a system II for three-dimensional representation of haircuts with a plurality of elements variable in length or rod-shaped elements for symbolic representation of hair lengths can be used for training both for trainees and advanced training persons. Moreover, it can also be used for examination purposes as well as for demonstration purposes in workshops, instructions and the like.

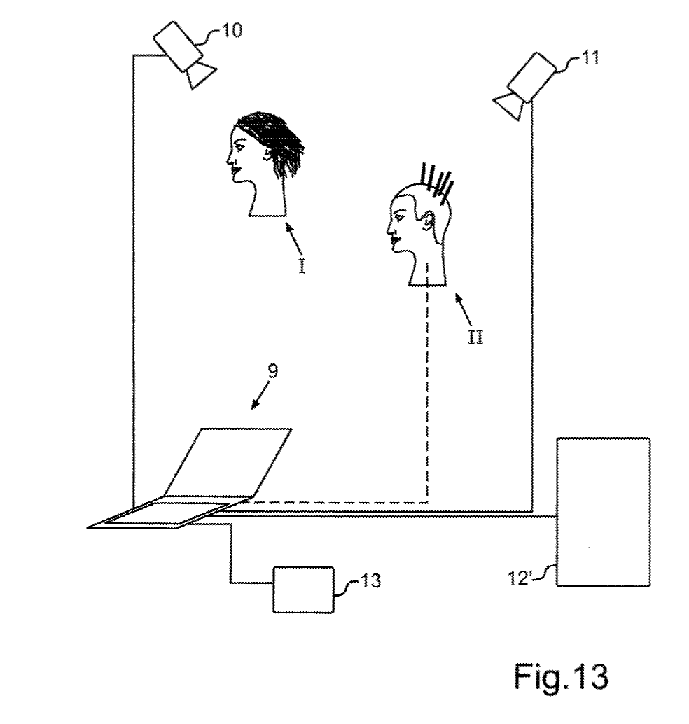

In FIG. 13, a system construction is shown in schematic illustration, which includes a system II besides a human head I. Moreover, an image processing/image capturing system is associated with it. Besides a computer unit 9, which for example can be a portable computer or the like, it includes a first camera 10 as well as a second camera 11. They each can be configured as 3D stereo cameras. Further cameras can also be provided. Moreover, a separate display unit 12′, such as for example a screen or the like, is provided. Image presentation can be effected on it by an image projection unit 13, for example a beamer or the like. Preferably, the cameras 10 and 11 and the image projection unit 13 are connected to the computer unit 9. If the display unit 12 is formed as an electronic display or other screen, it also can be electronically connected to the computer unit 9. These connections to the computer unit 9 can be configured wired or even wireless.

Moreover, a controller 5 of the system II, as it has been explained for example in the implementations according to FIG. 4 and FIG. 5, for data exchange with the computer unit 9 can also be provided. Here too, wireless or wired implementation can be realized.

By the system shown in FIG. 13, a real hair cutting procedure on the human head I can be pictorially acquired and stored in the computer unit 9. With a suitable image processing software, then, a three-dimensional representation of the human head I can be detected and stored. In particular, the image processing software can be configured such that specific hair lengths in the respective hair sections of the human head I can also be detected during the hair cutting procedure or determined by the software afterwards. Thereby, in principle, the shot storage of one or more reference haircuts can be allowed. Then, they also can be represented in simulated manner by the image processing software and optionally also be stored in the storage unit 5 of the model head 1. However, similarly, they can also be stored at the same time or only on the computer unit 9. The image processing software can also be formed as a computer program product for own simulated generation of reference haircuts without recording a real hair cutting procedure on the head I.

Moreover, it can be provided that the training on the system II can be optically captured by one or both cameras 10 and 11, respectively, and can also be stored. Both the acquisition of the hair cutting procedure on the human head I and the acquisition of a training attempt on the system II can be effected in the form of a video or single image sequences.

The acquisition and recording of a real hair cutting procedure on the human head I can be effected independent of the recording and acquisition of the training attempt on the system II. However, similarly, simultaneous acquisition and recording can also be possible. By the simultaneous approach, in case of subsequent inspection, analysis by comparison of the two procedures can be allowed. Moreover, the system II can be configured by the computer unit 9. For example, reference haircuts can additionally be stored or others can be deleted. Moreover, stored, recorded attempts of a training person can also be deleted or again be installed. In particular for demonstration purposes with plural persons, by an additional external display unit 12, transfer of the approaches can also be effected, and thus, comprehension can be allowed even for a great number of persons.

The start of the recording with the camera 10 and/or 11 can be effected at any times in user-defined manner or preprogrammed. For example, then, depending on specific phases of a hair cutting procedure, automatic or user-initiated start and stop can also occur.

Thereby, the essential phases of a hair cutting procedure or of a training attempt can be documented. The generated amount of data can then be minimized.

Post-processing of a recording for deleting or individually combining recordings or partial phases thereof can also be provided.

It can also be provided that at least two systems II can be controlled or configured by the computer unit 9.

1. System for three-dimensional representation of a haircut, including
a model head (1), and
a plurality of elements (2, 2a, 2b, 2a′, 2b′) variable in length for symbolic representation of hair lengths.

2. System according to claim 1, in which an element (2, 2a, 2b, 2a′, 2b′) variable in length has at least two partial elements (21 to 23; 21a to 21f), which are formed for symbolic representation of the hair length and connected to each other.

3. System according to claim 1, in which the length of an element (2, 2a, 2b, 2a′, 2b′) variable in length is reversibly variable.

4. System according to claim 1, in which the element (2, 2a, 2b, 2a′, 2b′) variable in length is reversibly variable in its length in itself in the direction of its longitudinal axis (A).

5. System according to claim 1, in which the element (2, 2a, 2b, 2a′, 2b′) variable in length is formed linearly and the variability in length is formed in axial direction of the element (2, 2a, 2b, 2a′, 2b′) with consistent linearity of the element (2, 2a, 2b, 2a′, 2b′).

6. System according to claim 1, in which the element (2, 2a, 2b, 2a′, 2b′) variable in length, separately considered, is disposed in stationary manner as a whole on the model head (1) upon length variation.

7. System according to claim 1, in which an element (2, 2a, 2b, 2a′, 2b′) variable in length has at least two partial elements (21 to 23; 21a to 21f), which are movable relatively to each other.

8. System according to claim 7, in which the partial elements (21 to 23; 21a to 21f) are movable relatively to each other in the direction of the longitudinal axis (A).

9. System according to claim 7, in which the element (2, 2a, 2b, 2a′, 2b′) variable in length is formed as a telescopic device.

10. System according to claim 1, in which the element (2, 2a, 2b, 2a′, 2b′) variable in length is resistant to bending.

11. System according to claim 1, in which an element (2, 2a, 2b, 2a′, 2b′) variable in length is formed rod-shaped.

12. System according to claim 11, in which the outer diameter of the element (2, 2a, 2b, 2a′, 2b′) variable in length is smaller than or equal to 7 mm, in particular smaller than or equal to 5 mm, especially smaller than or equal to 3 mm.

13. System according to claim 1, in which an element (2, 2a, 2b, 2a′, 2b′) variable in length is oriented substantially perpendicularly to the head surface (1b).

14. (canceled)

15. (canceled)

16. System according to claim 1, in which the length variation and/or the adjustment of an active position and/or of a passive position of an element (2, 2a, 2b, 2a′, 2b′) variable in length are automatically controllable.

17. System according to claim 1, which includes a length measuring element (8).

18. System according to claim 17, in which the length measuring element (8) is flexibly formed.

19. System according to claim 17, in which a length measuring element (8) is associated with each element (2, 2a, 2b, 2a′, 2b′) variable in length.

20. System according to claim 19, in which a length measuring element (8) is disposed at least in certain areas in a hollow element (2, 2a, 2b, 2a′, 2b′) variable in length.

21. System according to claim 19, in which a length measuring element (8) is movable relatively to the associated element (2, 2a, 2b, 2a′, 2b′) variable in length.

22. System according to claim 21, in which the length measuring element (8) extends out of the element (2, 2a, 2b, 2a′, 2b′) variable in length at an end facing away from the head surface (1b) of an associated element (2, 2a, 2b, 2a′, 2b′) variable in length.

23. System according to claim 1, which has an electronic storage unit (6), in which at least one reference haircut is stored.

24. System according to claim 23, in which the elements (2, 2a, 2b, 2a′, 2b′) variable in length, depending on a selected reference haircut, are automatically adjustable to the associated length controlled by a controller (5).

25. System according to claim 1, in which an element (2, 2a, 2b, 2a′, 2b′) variable in length is formed of a material transparent to light at least in certain areas.

26. System according to claim 25, in which an element (2, 2a, 2b, 2a′, 2b′) variable in length can be illuminated.

27. System according to claim 1, which includes an image capturing/image processing system.

28. System according to claim 27, in which the image capturing/image processing system has at least one optical detector unit (10, 11) and a computer unit (9).

29. System according to claim 27, in which the image capturing/image processing system is formed for recording videos of hair cutting procedures on a real head (I), which hair cutting procedures are storable.

30. System according to claim 27, in which the image capturing/image processing system is formed for recording videos of procedures for representing haircuts on the model head (1), which procedures are storable.

31. System according to claim 29, which is formed for comparison analysis of a hair cutting procedure performed on a real head (I) with a procedure for representing this hair cutting procedure on the model head (1).

32. Element for symbolic representation of a hair length, which is formed variable in length.

33. Method for three-dimensional representation of a haircut, in which plural elements (2, 2a, 2b, 2a′, 2b′) variable in length are each adjusted to an individual length for symbolic representation of the specific hair length, depending on a haircut to be specifically represented and depending on the position, in which an element (2, 2a, 2b, 2a′, 2b′) variable in length is disposed on a model head (1).
